(19) United States
(12) Patent Application Publication
(10) Pub. No.: US 2021/0165907 A1
(43) Pub. Date: Jun. 3, 2021

(54) SYSTEMS AND METHODS FOR INTELLIGENT AND QUICK MASKING

(71) Applicant: Morgan Stanley Services Group Inc, New York, NY (US)

(72) Inventors: Christopher J. MANN, Toms River, NJ (US); Kishore YERRAMILLI, Skillman, NJ (US); Vasantha KUMAR, Princeton, NJ (US); Richard VIANA, Summit, NJ (US); Joanki JIMENEZ, Montreal (CA); That Hung TON, Saint-Laurent (CA)

(73) Assignee: Morgan Stanley Services Group Inc., New York, NY (US)

(21) Appl. No.: 16/701,765

(22) Filed: Dec. 3, 2019

(51) Int. Cl. G06F 21/62; G06F 9/448; G06F 11/34

(52) U.S. Cl. CPC G06F 21/6245; G06F 11/3476; G06F 9/4498

(57) ABSTRACT

A method and system for masking private data (e.g., personally identifiable information (PII)) is provided. The method and system can include receiving log data from an application where at least a portion of the data is private, masking the data based on a type of the application. The method and system can also include an ability to update one or more rules that are applied to the masking based on the application type.

### FIELD OF THE INVENTION

The invention relates generally to masking log data. In particular, the invention relates to masking log data such that compute resources are minimally impacted and/or identification of the data to be masked is configurable.

### BACKGROUND

Many current computing systems, e.g., enterprise level computing systems, internet-based computing systems, capture and/or store data while executing. Data can be collected and stored (e.g., logged) while computing systems are executing one or more computer programs (e.g., applications). For example, an application can be running on a server, and during the application's execution various data associated with the execution can be captured and logged. The logged data can be transmitted, stored, and/or used for real-time and/or future analysis of the data. For example, logged data can be analyzed by computer administrators and/or coders to determine efficiency of the code or analyzed for demographic information.

One difficulty with logging data is that it may include data that is to be kept private, for example, Personally Identifiable Information (PII) of users of a computer system, or sensitive corporate information.

Currently, many institutions have data privacy rules (e.g., governmental, corporate, etc.) that can require certain data not be shared even within a particular institution, such that personnel within a particular institution may not be allowed to have access to certain data. This can require some of the data that personnel that analyzes/evaluates be hidden.

One solution to logging data where at least a portion of the data is to be kept private is to mask the data. Typically, masking data can involve converting the data to be kept private into another form. For example, assume data of a social security number. The social security number can rewritten such that its structure is kept (e.g., nine numbers with two dashes), but the values replaced with different values and/or a single digit/text (e.g., “X”) such that the rewritten data is an inauthentic version of the data.

One difficulty with masking data can include a decrease in computing resources (e.g., space for programs and/or amount of computations used versus total computation) available to the application due to, for example, the computing resources taken by the masking. Another difficulty with masking data can include adding time to the time it takes to log the data which can be problematic, for example, if the logged data is reviewed in real-time. Another difficultly with masking data can include difficulty with identifying the data to be masked within the log data, as the data to be logged can be unstructured and/or the data to be masked can occur anywhere in the data to be logged.

Typically, when masking data, the data to be masked is identified by matching the data to previously known data structures. This can require that each potential data structure is pre-programmed to allow the data to be masked to be identified in the log data.

### SUMMARY OF THE INVENTION

One advantage of the invention can include minimizing an amount of computing resources necessary to perform data masking. Another advantage of the invention can include an ability to mask data prior to logging without adding significant delay in comparison to logging without masking the data. For example, data can be masked on the order of 20 times faster. Another advantage of the invention can include an ability to identify the data to be masked within the logged data.

Another advantage of the invention can include automatically updating rules used to identify the data to be masked.

In one aspect, the invention involves a method for masking data. The method includes receiving, by a first computer, log data from an application wherein at least a portion of the log data is data to be masked. The method also includes masking, by the first computer, the portion of the log data to be masked, wherein the masking is based on an application type of the application that output the log data. The method also includes transmitting, by the first computer, the masked log data from the first computer to a second computer.

In some embodiments, the masking involves receiving, by the first computer, one or more rules that are specific to the application type of the application, wherein the one or more rules identify the portion of the log data to be masked, and applying, by the first computer, the one or more rules to the log data via a finite state machine to mask the portion of the log data to be masked.

In some embodiments, the one or more rules are updated when an analysis of the log data results in a new pattern being identified for the application. In some embodiments, the one or more rules are updated offline. In some embodiments, the log data is masked upon receipt from the application. In some embodiments, the application resides on the first computer. In some embodiments, the log data is unstructured data.

In some embodiments, the method also involves storing, by the second computer, the masked log data, transmitting, by the second computer, the masked log data to a database, or any combination thereof. In some embodiments, the method also involves for a user that requires the portion of the data identified to be masked to remain unmasked in the log data, transmitting, by the first computer, the log data with the PI data unmasked to a third computer.

In some embodiments, the portion of the data to be masked is personally identifiable information (PII).

In another aspect, the invention includes a system for masking data. The system includes a first computer hosting an application that outputs log data, wherein at least a portion of the log data is data to be masked, and a log data masking module that masks the portion of the log data to be masked, wherein the masking is based on an application type of the application, wherein the first computer transmits the masked log data to a second computer.

In some embodiments, the system includes a rule storage that transmits one or more rules to the log data masking module, wherein the one or more rules identify the portion of the data to be masked in the log data. In some embodiments, the log masking module comprises a finite state machine.

In some embodiments, the one or more rules are updated when an analysis of the log data results in a new pattern being identified for the application. In some embodiments, the one or more rules are updated offline. In some embodiments, the log data is masked upon receipt from the application.

In another aspect, the invention includes a computer program product comprising instructions which, when the program is executed cause the computer to receive log data from an application hosted on a first computer wherein at least a portion of the log data is to be masked, mask, by the first computer, the portion of the log data to be masked, wherein the masking is based on an application type of the application that output the masked log data, and transmit, by the first computer, the masked log data from the first computer to a second computer.

In some embodiments, the computer program product includes further instructions which, when the program is executed cause the computer to receive, by the first computer, one or more rules that are specific to the application type of the application, wherein the one or more rules identify the portion of the data to be masked in the log data, and apply, by the first computer, the one or more rules to the log data via a finite state machine to mask the portion of the data to be masked in the log data.

In some embodiments, the log masking module comprises a finite state machine. In some embodiments, the one or more rules are updated when an analysis of the log data results in a new pattern being identified for the application. In some embodiments, the log data is masked upon receipt from the application.

### BRIEF DESCRIPTION OF THE DRAWINGS

Non-limiting examples of embodiments of the disclosure are described below with reference to figures attached hereto that are listed following this paragraph. Dimensions of features shown in the figures are chosen for convenience and clarity of presentation and are not necessarily shown to scale.

The subject matter regarded as the invention is particularly pointed out and distinctly claimed in the concluding portion of the specification. The invention, however, both as to organization and method of operation, together with objects, features and advantages thereof, can be understood by reference to the following detailed description when read with the accompanied drawings. Embodiments of the invention are illustrated by way of example and not limitation in the figures of the accompanying drawings, in which like reference numerals indicate corresponding, analogous or similar elements, and in which:

FIG. 1 is a block diagram of a system architecture for masking PII, according to some embodiments of the invention.

FIG. 2 is a flow chart of a method for masking PII, according to some embodiments of the invention.

FIG. 3 is a block diagram illustrating an example of a finite state machine, according to some embodiments of the invention.

FIG. 4 is a block diagram of a computing device which can be used with embodiments of the invention.

It will be appreciated that for simplicity and clarity of illustration, elements shown in the figures have not necessarily been drawn accurately or to scale. For example, the dimensions of some of the elements can be exaggerated relative to other elements for clarity, or several physical components can be included in one functional block or element.

### DETAILED DESCRIPTION

In the following detailed description, numerous specific details are set forth in order to provide a thorough understanding of the invention. However, it will be understood by those skilled in the art that the invention can be practiced without these specific details. In other instances, well-known methods, procedures, and components, modules, units and/or circuits have not been described in detail so as not to obscure the invention.

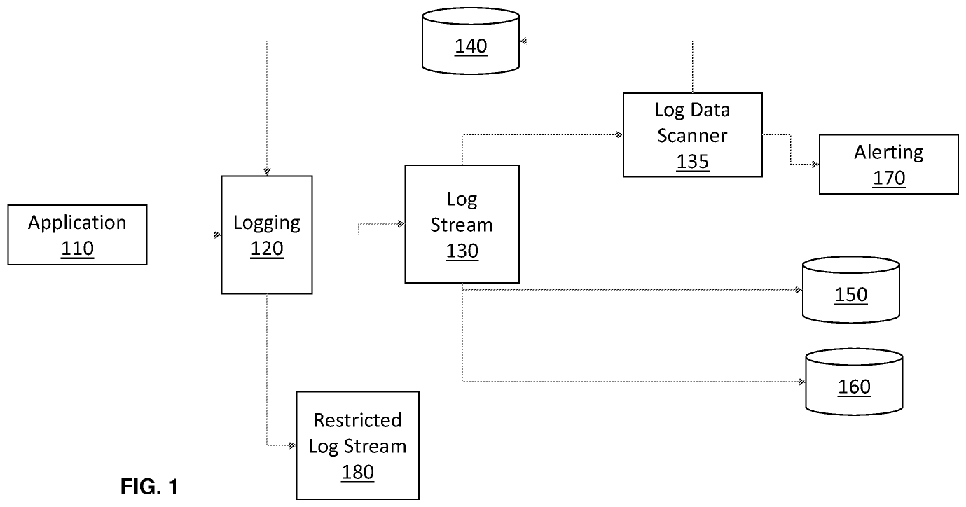

In general, the invention can involve masking at least a portion of data that is to be logged. Software applications can generate vastly different formats of log files. Each software application typically has a unique (or substantially unique) sequence of textual and/or numeric fields that make up the data within a log file. The invention can provide the capability to allow each unique software application (e.g., type of application and/or application type) can mask the log data with different rules (e.g., completely different rules or partially different rules). This can be controlled centrally and/or stored in a logging configuration database (e.g., element 140 as described below in further detail with respect to FIG. 1)

The masking can be applied to any data that is output from an application that is to be logged. For example, the masking can occur to data that is indicated as private data (e.g., PII data). The masking can occur at the same computing device that hosts the application. The masking can be based on one or more rules. The one or more rules can be updated, for example, based on the application type. The masking can be done with a negligible impact on the computing resources at the computing device that hosts the application (e.g., less than 2% of the compute resources) and/or in an amount of time that results in a negligible delay on writing to the log, such that the logged data can be accessed in real-time. The masking rules can be determined and/or updated based on the data output by the application. The masking rules can be associated with a particular application.

FIG. 1 is a block diagram of a system 100 for masking data, according to some embodiments of the invention. The system 100 includes an application 110, a logging module 120 (e.g., a Logging as a Service (LaaS) agent), a log stream module 130, a log data scanner module 135, a logging configuration database 140, a long-term storage database 150, a secure analytics database 160, an alerting module 170 and a restricted log stream module 180.

The application 110 can be in communication with the logging module 120. The application 110 can include instructions to output data to the logging module 120 during operation. For example, the application 110 can include a code trace. The data output by the application 110 can be unstructured data, structured data, or any combination thereof.

The application 110 can output the data to be logged to the logging module 120. The data that is output by the application 110 can include data that is to be kept private. The data that is to be kept private can be input by a system administrator, based on one or more policies of a particular organization, based on machine learning algorithms that are known in the art and take the data output by the application as input, or any combination thereof. The data to be kept private can include PI data, entity identification data, and/or any other data that is identified as being sensitive and to be kept private. The data to be kept private can occur anywhere within the data that is output by the application 100.

The logging module 120 can identify data to be masked within the data output by the application 110. The logging module 120 can identify the data to be masked based one or more one or more rules received from the logging configuration database 140. The logging module 120 can identify the data to be masked in real-time.

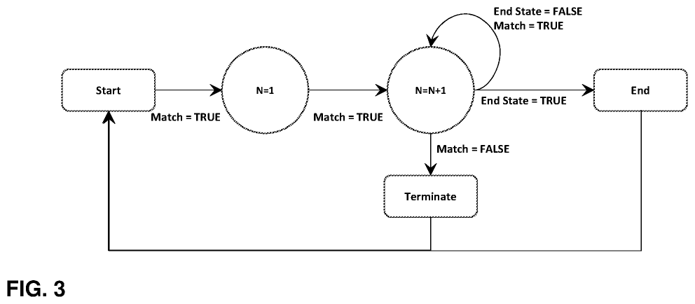

The logging module 120 can include a finite state machine (e.g., as described in further detail below with respect to FIG. 3). The finite state machine can receive as input the one or more rules and the data output from the application 110. The finite state machine can identify the data to be masked within the data output from the application 110. The logging module 120 can mask the data identified by the finite state machine. The logging module 120 can mask the data in real-time. The logging module 120 can identify and mask the data in micro-seconds. The logging module 120 can mask all of the data output from the application 110, some of the data output from the application 110, or none of the data output from the application 110.

The logging module 120 can transmit the data output from the application 110 with at least a portion of the data masked to the log stream module 130. In some embodiments, it is desired to log data that is identified by the finite state machine without masking the data. The logging module 120 can transmit the data output from the application 110 without being masked to the restricted log stream module 180.

The log stream module 130 can communicate with the logging module 120. The log stream module 130 can receive the data output from the application 110 that has at least a portion masked from the logging module 120. The log stream module 130 can distribute its received data to the log data scanner module 125, the long-term storage database 150 and/or the secure analytics database 160. The long-term storage database 150 can be a computer storage where the data is stored over a long period of time (e.g., seven years) The secure analytics database 160 can be a computer storage where the data is stored for analysis, for example, by an application development team.

The log data scanner module 125 can analyze the data it receives from the log stream module 130 to identify data in the log data that is private data, but that wasn't identified or masked by the logging module 120. For example, assume that the logging module 120 received one rule that identified social security number as a private data item. Also assume that the data output from the application 110 includes date of birth and social security number. In this scenario, the logging module 120 only masks the social security number and not the date of birth. The log data scanner module 125 can identify that the date of birth is in the log data and that it is private data. The log data scanner module 125 can create a new rule and transmit the new rule to the logging configuration database 140. The new rule can be associated with application 110. In this manner, rules for masking can be associated with a particular application, and rules for masking can be automatically determined and/or automatically updated. The log data scanner module 125 can analyze the data it receive offline.

The logging configuration database 140 can be in communication with the log stream module 130. The logging configuration database 140 can receive one or more rules for masking. The one or more rules can be received from the log data scanner module 125, a user administrator, and/or input via a configuration file.

In some embodiments, the alerting module 170 communicates with the log data scanner module 135 to analyze the data in the log data that was identified by the log data scanner module 135 as being private to determine if the identified data is falsely identified.

For example, assume a new pattern is identified. The alerting module 170 can determine if the newly identified pattern is likely true or false. In some embodiments, the alerting module 170 checks a stored pattern file that indicates patterns that are likely true (e.g., patterns from other applications and/or specified by system admins). If the alerting module 170 cannot find the stored patterns in the stored pattern file, then the alerting module 170 can transmit an alert that the pattern may be false. In some embodiments, an administrator can review the possibly false pattern and decide whether or not the pattern can be added.

The application 110 and the logging module 120 can reside on a first computing device. In embodiments where the application 110 and the logging module 120 reside on the first computing device, the masking work-load can distributed among the computing devices of the applications, rather than performing all masking on a central logging server. The log stream module 130, the log data scanner module 135, the logging configuration database 140, the long-term storage database 150, the secure analytics database 160, the alerting module 170 and the restricted log stream module 180 can reside on distributed computing devices.

In various embodiments, the components of the system 100 can be hosted on a single computing device or a combination of computing devices. In various embodiments, the application 110, the logging module 120, the log stream module 130, the log data scanner module 135, the logging configuration database 140, the long-term storage database 150, the secure analytics database 160, the alerting module 170 and the restricted log stream module 180 can each be hosted on a different computing device.

In various embodiments, the application 110, the logging module 120, the log stream module 130, the log data scanner module 135, the logging configuration database 140, the long-term storage database 150, the secure analytics database 160, the alerting module 170 and the restricted log stream module 180 reside in any configuration on any number of computing devices.

In various embodiments, any of the components of the system 200 can be split into being hosted on two or more computing devices. For example, the log data scanner module 135 can be hosted on two computing devices. In various embodiments, any combination of the components of the system 200 can be hosted on physical and/or virtual machines.

In various embodiments, one or more additional applications are in communication with the logging module 120. In some embodiments, each application has a corresponding logging module, and multiple application/logging module pairs communication with the log stream module 130 and the logging configuration database 140. In these embodiments, the logging configuration database 140 can include one or more rules that are application specific. Such that for a first application/logging module pair, a first set of rules is transmitted to the logging module, and for a second application/logging module pair, a second set of rules is transmitted to its corresponding logging module. In this manner, the logging module is configurable based on application type.

In various embodiments, the application 110 is a trading application, account opening application, advisory application, trading application, billing application, and/or any combination thereof. In various embodiments, the application 110 is any application that outputs log data.

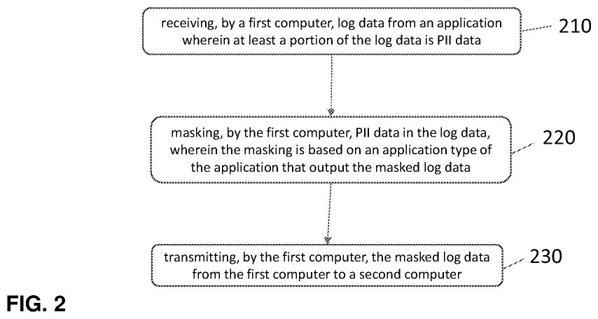

FIG. 2 is a flow chart of a method for data (e.g., PI data), according to some embodiments of the invention. The method involves receiving, by a first computer (e.g., a first computer hosting the application 110 and the logging module 120, as described above in FIG. 1), data to be logged (e.g., log data) from an application (e.g., application 110, as described above in FIG. 1) wherein at least a portion of the log data is PI data (Step 210).

The method also involves masking, by the first computer, PI data that is present in the log data, wherein the masking is based on an application type of the application that output the masked log data (Step 220).

In some embodiments, masking the PI data involves receiving, by the first computer, one or more rules that are specific to the application type of the application (e.g., the logging module 120 receiving the one or more rules from the logging configuration database 140, as described above in FIG. 1.) The one or more rules can identify the PI data in the log data. For example, assume that an enterprise system includes two applications, application #1 having a first type and application #2 having a second type. Masking data from application #1 can involve applying a first set of rules that are specific to application #1 (e.g., as identified by the log data scanner module 135, as described above in FIG. 1) and masking data from application #2 can involve applying a second set of rules that are specific to application #2 (e.g., as identified by the log data scanner module 135, as described above in FIG. 1). In various embodiments, the first set of rules and the second set of rules have at least some rules that are different.

In some embodiments, all applications in the system that are the application type of application #1 have the same rules as application #1. In some embodiments, applications of the same type can have different rules, if for example, the data collected for logging is different due the fact that they are different applications, even if they are of the same type.

In some embodiments, masking the PI data also involves applying, by the first computer, the one or more rules to the log data via a finite state machine to mask the PI data in the log data. In some embodiments, the finite state machine is a deterministic finite state machine. Turning to FIG. 3, FIG. 3 is an example of a deterministic finite state machine, according to an illustrative embodiment of the invention. The deterministic finite state machine can include the following:

TABLE 1

| State Type | Algorithm Significance |
|---|---|
| Start | Indicates that the algorithm has identified the first |
| | character of PII data element |
| Next | Indicates that sequence of characters is still matching |
| | the PII data element pattern |
| End | Indicates definitive occurrence of PII data element |
| | (specified pattern) |
| Terminate | Indicates a failed pattern for the PII data element |

The deterministic finite state machine can receive as input: 1—valid symbols and/or 2—deterministic states. The one or more rules can describe valid symbols and/or deterministic states. The one or more rules can include rules to identify data have a fixed pattern and/or a key/value pattern.

The one or more rules can include a fixed pattern and/or a key/value pattern. The one or more rules can be specified as follows:

For data that is social security number, a fixed pattern can include the following rules:
characters: eleven (11) characters (e.g., 9 digits with two hyphen separators);
format: “ddd-dd-dddd” where d is a digit.

In this example, the finite state machine can receive the log data as input and the rules of the fixed pattern as input. Referring to Table 1, in this example, the finite state machine can have a state of start when a first digit in the log data is identified. If the next digit of the log data is also a digit then the finite state machine can be in the state of Next. The finite state machine can continue to loop through the log data seeking a match for to the rule, until either the entire fixed pattern is matched, which in that case the state of the finite state machine switches to End, and the matched log data is identified as being data for masking, or the fixed pattern is not matched, which in that case the finite state machine can switch to a Terminate state. As is apparent to one of ordinary skill in the art, the foregoing is an example and other rules can be used to identify other patterns with the finite state machine.

For data that is a social security number, key/value pattern can include the following rules:
key: sequence of characters with sub-string (e.g., only alphabets and ‘_’) “ssn/tax”;
separator: one or more occurrence of special character or substring “value”;
value: sequence of exactly 9 digits;
format: “ssn”:“ddddddddd”;
example: “SSN”:“123456789”.

For data that is a debit card number, a fixed pattern can include the following rules:
characters: nineteen (19) characters (e.g., sixteen 16 digits with hyphen after every 4 digits); format: dddd-dddd-dddd-dddd;
example: 1234-1234-1234-1234.

For data that is a debit card number, a key/value pattern can include the following rules:
key: sequence of characters with sub-string (e.g., only alphabets) “debitcard”;
separator: one or more occurrence of special character;
value: sequence of exactly sixteen (16) digit;
format: “debitcard”:“dddddddddddddddd”;
example: “debitCardNumber”:“5549621081135467”.

For data that is an account number, a fixed pattern can include the following rules:
characters: five (5) or six (6) digits (e.g., with hyphen after three (3) digits and with/without hyphen 2/3 digits at the end);
format: ddd-ddddd;
example: 123-12345.

For data that is an account number, a key/value pattern can include the following rules:
key: sequence of characters with sub-string (e.g., only alphabets) account/acctnum/acctid;
separator: one or more occurrence of special character;
value: sequence of either 5, 6 or 9 digits;
format: “ACCOUNT”:“ddddd”;
example: “ACCOUNT”:“12345”.

For data that is an account number, a fixed pattern can include the following rules: fixed Pattern: thirteen (13) characters (e.g., with hyphen and Parenthesis);
format: (ddd)ddd-dddd;
example: (123)123-1234.

For data that is account number, key/value pattern can include the following rules:
key: sequence of characters with sub-string (e.g., only alphabets and ‘_’) “phone”/“fax”;
separator: one or more occurrence of special character;
value: sequence of exactly 10/11/12 digits;
format: “phone”:“dddddddddd”;
example: “phone”:“1234567890”.

For data that in email, fixed pattern can include the following rules:
characters: any valid email having ‘@‘ and’.’ in proper order;
format: <alphaNumericCharacters>@<alphabets>.<alphabets>;
example: firstname.lastname@domain.com.

The method also involves transmitting, by the first computer, the masked log data from the first computer to a second computer (e.g., a computer that hosts the log stream module 130, as described above in FIG. 1) (Step 230).

As is apparent to one of ordinary skill in the art, the method described in FIG. 2 and the examples given have described PII data as an example of the data to be masked. As described throughout the specification, the data to be masked can be any data that is desired to be kept private in the log data.

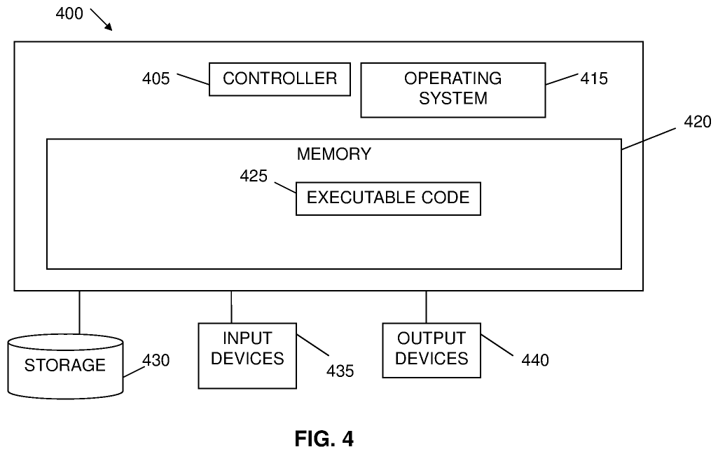

FIG. 4 shows a block diagram of a computing device 400 which can be used with embodiments of the invention. Computing device 400 can include a controller or processor 105 that can be or include, for example, one or more central processing unit processor(s) (CPU), one or more Graphics Processing Unit(s) (GPU or GPGPU), a chip or any suitable computing or computational device, an operating system 415, a memory 420, a storage 430, input devices 435 and output devices 440.

Operating system 415 can be or can include any code segment designed and/or configured to perform tasks involving coordination, scheduling, arbitration, supervising, controlling or otherwise managing operation of computing device 400, for example, scheduling execution of programs. Memory 420 can be or can include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 420 can be or can include a plurality of, possibly different memory units. Memory 420 can store for example, instructions to carry out a method (e.g. code 425), and/or data such as user responses, interruptions, etc.

Executable code 425 can be any executable code, e.g., an application, a program, a process, task or script. Executable code 425 can be executed by controller 405 possibly under control of operating system 415. For example, executable code 425 can when executed cause masking of personally identifiable information (PII), according to embodiments of the invention. In some embodiments, more than one computing device 400 or components of device 400 can be used for multiple functions described herein. For the various modules and functions described herein, one or more computing devices 400 or components of computing device 400 can be used. Devices that include components similar or different to those included in computing device 400 can be used, and can be connected to a network and used as a system. One or more processor(s) 405 can be configured to carry out embodiments of the invention by for example executing software or code. Storage 430 can be or can include, for example, a hard disk drive, a floppy disk drive, a Compact Disk (CD) drive, a CD-Recordable (CD-R) drive, a universal serial bus (USB) device or other suitable removable and/or fixed storage unit. Data such as instructions, code, NN model data, parameters, etc. can be stored in a storage 430 and can be loaded from storage 430 into a memory 420 where it can be processed by controller 405. In some embodiments, some of the components shown in FIG. 4 can be omitted.

Input devices 435 can be or can include for example a mouse, a keyboard, a touch screen or pad or any suitable input device. It will be recognized that any suitable number of input devices can be operatively connected to computing device 400 as shown by block 435. Output devices 440 can include one or more displays, speakers and/or any other suitable output devices. It will be recognized that any suitable number of output devices can be operatively connected to computing device 400 as shown by block 440. Any applicable input/output (I/O) devices can be connected to computing device 400, for example, a wired or wireless network interface card (NIC), a modem, printer or facsimile machine, a universal serial bus (USB) device or external hard drive can be included in input devices 435 and/or output devices 440.

Embodiments of the invention can include one or more article(s) (e.g. memory 420 or storage 430) such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein.

One skilled in the art will realize the invention can be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In the foregoing detailed description, numerous specific details are set forth in order to provide an understanding of the invention. However, it will be understood by those skilled in the art that the invention can be practiced without these specific details. In other instances, well-known methods, procedures, and components, modules, units and/or circuits have not been described in detail so as not to obscure the invention. Some features or elements described with respect to one embodiment can be combined with features or elements described with respect to other embodiments.

Although embodiments of the invention are not limited in this regard, discussions utilizing terms such as, for example, “processing,” “computing,” “calculating,” “determining,” “establishing”, “analyzing”, “checking”, or the like, can refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that can store instructions to perform operations and/or processes.

Although embodiments of the invention are not limited in this regard, the terms “plurality” and “a plurality” as used herein can include, for example, “multiple” or “two or more”. The terms “plurality” or “a plurality” can be used throughout the specification to describe two or more components, devices, elements, units, parameters, or the like. The term set when used herein can include one or more items. Unless explicitly stated, the method embodiments described herein are not constrained to a particular order or sequence. Additionally, some of the described method embodiments or elements thereof can occur or be performed simultaneously, at the same point in time, or concurrently.

1. A method for masking data, the method comprising:
receiving, by a first computer, log data from an application wherein at least a portion of the log data is data to be masked;
receiving, by the first computer, one or more rules that are specific to the application type of the application, wherein each of the one or more rules comprises a fixed pattern or a key/value pattern and identifies the portion of the log data to be masked;
masking, by the first computer, the portion of the log data to be masked by applying each of the one or more rules to the log data via a deterministic finite state machine by looping through deterministic states of start, next, end and terminate for each rule of the one or more rules that is satisfied; and
transmitting, by the first computer, the masked log data from the first computer to a second computer.

2. (canceled)

3. The method of claim 1 wherein the one or more rules are updated when an analysis of the log data results in a new pattern being identified for the application.

4. The method of claim 1 wherein the one or more rules are updated offline.

5. The method of claim 1 wherein the log data is masked upon receipt from the application.

6. The method of claim 1 wherein the application resides on the first computer.

7. The method of claim 1 wherein the log data is unstructured data.

8. The method of claim 1 further comprising:
storing, by the second computer, the masked log data, transmitting, by the second computer, the masked log data to a database, or any combination thereof.

9. The method of claim 1 further comprising:
for a user that requires the portion of the data identified to be masked to remain unmasked in the log data, transmitting, by the first computer, the log data with the PI data unmasked to a third computer.

10. The method of claim 1 wherein the portion of the data to be masked is personally identifiable information (PII).

11. A system for masking data, the system comprising:
a first computer hosting:
i) an application that outputs log data, wherein at least a portion of the log data is data to be masked, and
ii) a rule storage that transmits one or more rules to the log data masking module, wherein each of the one or more rules comprises a fixed patter or a key/value pattern and identify the portion of the data to be masked in the log data.
iii) a log data masking module that masks the portion of the log data to be masked by applying each of the one or more rules to the log data via a deterministic finite state machine by looping through deterministic states of start, next, end and terminate for each rule of the one or more rules that is satisfied, wherein the masking is based on an application type of the application,
wherein the first computer transmits the masked log data to a second computer and wherein the log masking module comprises a finite state machine.

12. (canceled)

13. (canceled)

14. The system of claim 11 wherein the one or more rules are updated when an analysis of the log data results in a new pattern being identified for the application.

15. The system of claim 11 wherein the one or more rules are updated offline.

16. The system of claim 11 wherein the log data is masked upon receipt from the application.

17. A computer program product comprising instructions which, when the program is executed cause a first computer to:
generate log data from an application hosted on the first computer wherein at least a portion of the log data is to be masked;
receive one or more rules that are specific to the application type of the application, wherein each of the one or more rules comprises a fixed pattern or a key/value pattern and identify the portion of the log data to be masked;
mask the portion of the log data to be masked by applying each of the one or more rules to the log data via a deterministic finite state machine by looping through the states of start, next, end and terminate for each rule of the one or more rules that is satisfied; and
transmit the masked log data from the first computer to a second computer.

18. (canceled)

19. The computer program product of claim 17 wherein the log masking module comprises a finite state machine.

20. The computer program product of claim 17 wherein the one or more rules are updated when an analysis of the log data results in a new pattern being identified for the application.

21. The computer program product of claim 17 wherein the log data is masked upon receipt from the application.
